(19) United States
(12) Patent Application Publication
(10) Pub. No.: US 2004/0267811 A1
(43) Pub. Date: Dec. 30, 2004

(54) Host initiated display, host initiated display application program interface, and host initiated display method

(75) Inventors: Kenneth Carlin Nelson, Hollister, CA (US); Marilene Araujo Noronha, San Jose, CA (US); Eileen HongLian Wang, San Jose, CA (US); Robert Ellwood Weaver, Frederick, MD (US)

Correspondence Address: RICHARD M. GOLDMAN, 371 ELAN VILLAGE LANE, SUITE 208, CA, 95134, US

(73) Assignee: International Business Machines Corporation

(21) Appl. No.: 10/607,864

(22) Filed: Jun. 27, 2003

(51) Int. Cl. G06F 7/00

(52) U.S. Cl. 707/104.1

(57) ABSTRACT

A method for rendering an object from a text and numerical centric application to a graphical user interface centric application through a host initiated display application. When the graphical user interface customer application requests an object, for example, a display, a print, folder contents, or the like, from a text or numerical centric line of business application, the line of business application initiates a “host initiated display” application program interface (‘api”), and calls a workstation listener. The content manager host sends the customer application request to the workstation listener, which launches the content manager graphical user interface (GUI) client. The content manager graphical user interface (GUI) client builds a request for the object and sends the request to the content manager application for host initiated display. The content manager application responds to content manager client and renders object to user.

### FIELD OF THE INVENTION

The invention relates to database management systems and more particularly to accessing legacy applications that do not support graphical user interfaces or an application that is graphical user interface centric.

### BACKGROUND OF THE INVENTION

Content Management is an infrastructure to manage the full spectrum of digital information. Large collections of scanned images, facsimiles, electronic office documents, XML and HTML files, computer output, audio, video, multimedia, and virtual reality content can be stored and accessed through the content management system. The content management system integrates content with line of business, customer service, ERP, digital asset management, distance learning, Web content management or other applications to accelerate benefits across the enterprise.

In one embodiment the content manager product may be visualized as a triangle, its three vertices being the client, a library server and an object server (resource manager). The client is the user's interface which gives the user the capability of storing, searching for, and, marking-up documents (or to use the more general term, objects). The library server is the equivalent of a card catalog which holds information about the objects, including their location. The object server (OS), also referred to herein as the resource manager (RM) is where either the actual object or a pointer to the actual object is stored.

The core Library Server logic (except for system utilities and housekeeping tasks) is packaged as a set of relational data base (RDB) stored procedures (SPs) containing embedded SQL statements. Each stored procedure (SP) is precompiled and runs on a relational database (RDB) server. Thus each Library Server (LS) process is merely a relational database (RDB) server process. The interface to a Library Server is SQL, through which either stored procedures (SPs) can be called or SQL SELECT statements (including cursor support) can be executed. Remote access to Library Server is via a relational database (RDB) client.

The Resource Managers (RMs) may support different/multiple access protocols. The resource manager (RM)—object server (OS) supports the HTTP protocol. The basic information entities managed by the Library Server are “items.” “Items” as used herein come in two types, simple items and resource items. Resource items can have content associated with them that is stored in one or more Resource Managers. Resource items point to their content via Resource URL-RELATED DATA. One attribute of “items” is their “folder.”

The library server (LS) and object server (OS) (resource manager (RM)) are separate processes, often running on different machines. In operation, clients first contact the library server (LS) to create/update an index for an object, and to determine where the object is to be stored/replaced. The client then sends a request to the object server (OS) to store/replace the object.

The content manager system is heavily graphics intensive, much of the data and content is graphic, and the end user is presented with graphical user interfaces. Frequently, however, graphics data must be integrated with legacy textual and numeric data running on legacy applications.

One challenge is interfacing a graphics centric content manager application with a text and numeric centric application, such as IBM CICS (Customer Information Control System). IBM CICS is a widely used legacy on line transaction processing (OLTP) system. CICS, together with the COBOL programming language, has formed over the past several decades the most common set of tools for building of large enterprise mainframe resident customer transaction applications. To be noted is that many of the enterprise legacy applications still in use are COBOL/CICS applications. Using the textual application programming interface provided by CICS, a programmer can write programs that communicate with online users and read from or write to customer and other records (orders, inventory figures, customer data, and so forth) in a database (usually referred to as “data sets”) using CICS facilities rather than other access methods directly.

Within this context, a text/numeric based application, that is, a line of business application, may need to invoke the GUI centric content manager application. While there are various ways to accomplish this, it is most desirable to accomplish this in a way that is transparent to the user.

Thus a need exists to be able to transparently invoke a graphics centric end user application from a text and numeric centric application.

### SUMMARY OF THE INVENTION

The method, system, and program product of our invention enables an end user to transparently invoke a graphics centric end user application from a text and numeric centric application

As described herein, when an end user at a customer application requests an object, for example, a display, a print, folder contents, or the like, from a line of business application, the line of business application initiates a “host initiated display” application program interface (‘api”), and calls a workstation listener. The content manager host sends the customer application request to the workstation listener, which launches the graphical user interface client, for example, the Content Manager graphical user interface (GUI) client. The graphical user interface client, for example, the Content Manager graphical user interface (GUI) client builds a request for the object and sends the request to the content manager application for host initiated display. The content manager application responds to content manager client and renders object to user.

As used herein a listener is a software module or application used to facilitate the association between a connection and a destination. and deployed message-driven bean. More specifically, a listener starts a service on a received command, and provides an appropriate link.

A still further aspect of our invention is a program product.

### THE FIGURES

FIG. 1 is an overview of the three elements of a content management system of the prior art, the client application, the library server, and the resource manager, and the actions between them in storing and replacing an item.

FIG. 2 is an overview of the host initiated display application program interface of the invention with the three elements of a content management system, the client application, the library server, and the resource manager, and the actions between them in storing and replacing an item.

FIG. 3 is a high level flowchart of the method of the invention.

### DETAILED DESCRIPTION OF THE INVENTION

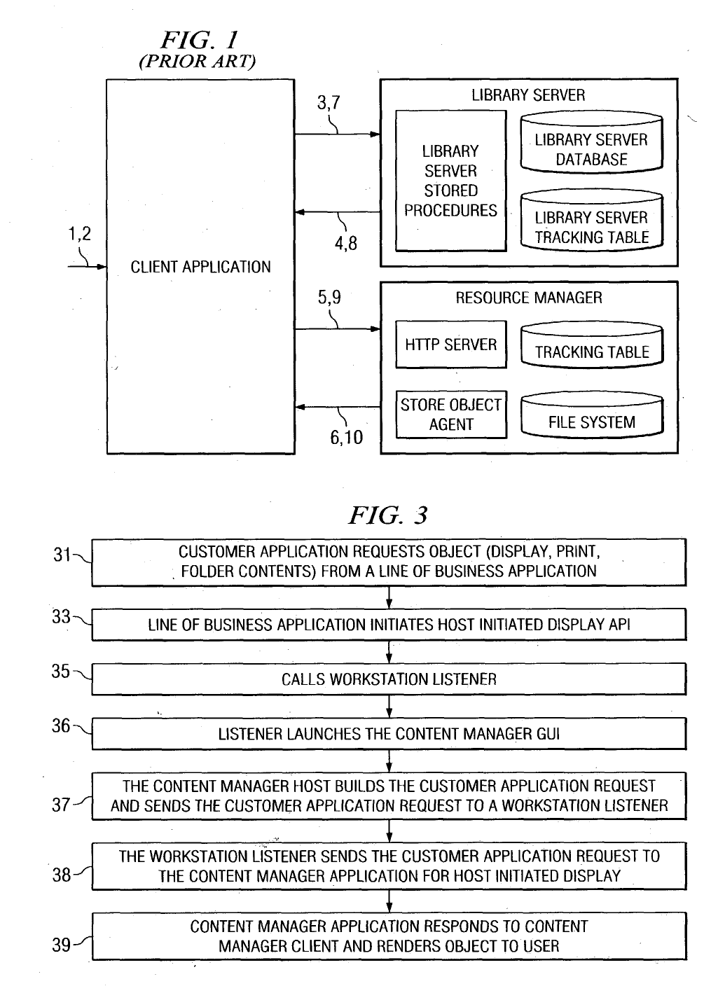

FIG. 1 illustrates generally the client, the library server, and the resource server, and how they interact to store an item in a situation where there is no text based or numeric based legacy line of business application (the “Prior Art”). As shown in the FIGURE, a client application, a library server, and a resource manager are running. The library server includes library server stored procedures, a library server database, and a library server tracking table. The resource manager includes an HTTP server, a Content Management resource manager “Store Object” agent, a resource manager tracking table data base, and a file system.

At a high level, the client begins a transaction, 1, by sending a request to the library server to create or retrieve a catalog entry (as an index entry) for a content management object, 3. In response, the client receives information back from the library server as to where to find or store the object, 4. The client then sends a request to the resource manager to retrieve or store the object, 5. The client receives a response, 6, from the resource manager with object metadata. This metadata includes, by way of exemplification, the object name, size, and transaction timestamp. The client sends this metadata to the library server, 7. The library server replies to the client indicating success or failure of the of the metadata transaction, 8, at which point the client commits the library server updates, 9. After committing the library server updates, the client sends “end transactions” to the resource manager to delete its tracking table record. The client receives a reply from the resource manager indicating success or failure in completing the processing requested.

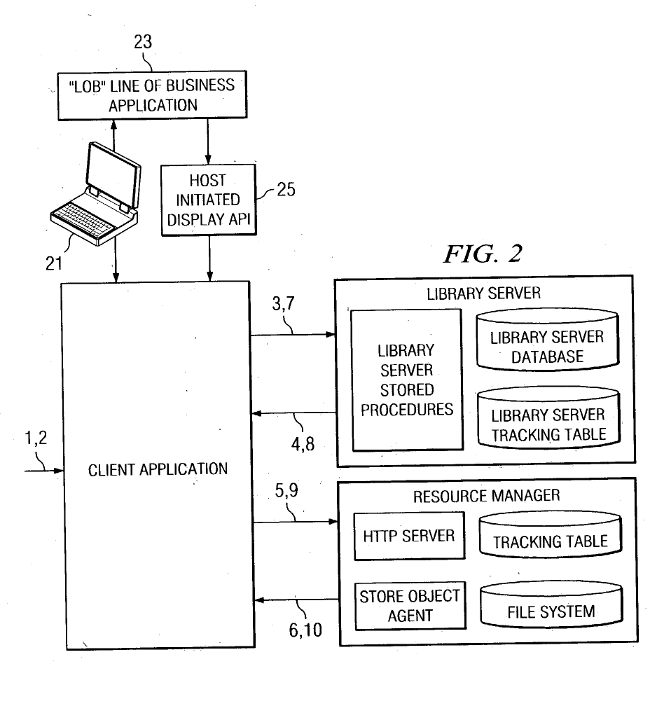

FIG. 2 illustrates generally the client, the library server, the resource server, with the additional host initiated display application program interface between the client application and the line of business application. As shown in FIG. 2, an end user at a customer application, 21, requests an object, for example, a display, a print, folder contents, or the like, from a line of business application, 23. The line of business application initiates a “host initiated display” application program interface (‘api”), 25, and calls a workstation listener, which launches the graphical user interface client, for example, the Content Manager (CM) graphical user interface (GUI) client. The line of business application host, 23, sends the customer application request to the workstation listener, 4. The CM GUI client builds a request for the object and sends the request to the content manager application, 7, for host initiated display. The content manager application responds to the content manager client and renders the object to user, 8.

FIG. 3 is a flow chart showing the customer application requesting the object (display, print, folder contents) from a line of business application, 31. Next, the line of business application initiates host initiated display api, 33, and calls the workstation listener, 35 which launches the graphical user interface client, 36 for example, the Content Manager (CM) graphical user interface (GUI) client, and the CM GUI client builds the request for the object, 37. The content manager host sends the customer application request to the content manager application for host initiated display, 38, and the content manager application responds to the content manager client and renders object to user, 39.

The invention further includes a program product that may be used to configure and control a computer to respond when an end user at a customer application requests an object, for example, a display, a print, folder contents, or the like, from a line of business application. The program product enables and facilitates the line of business application to initiate a “host initiated display” application program interface (‘api”), and call a workstation listener. The program code then causes the content manager host to send the customer application request to the workstation listener. The workstation listener builds (or initiates the building of) a request for the object and sends the request to the content manager application for host initiated display. Then, the program code causes the content manager application responds to content manager client and renders object to user.

As used herein, a program product is computer readable program code on one or more media, said program code being capable of controlling and configuring a computer system having one or more computers. Then one or more computers may be configured and controlled to carry out the method described herein. Alternatively, the program may be one or more of encrypted or compressed for subsequent installation, and may be resident on media or on an installation server.

While our invention has been described with respect to certain preferred embodiments and exemplifications, it is not intended to be limited thereby, but solely by the claims appended hereto.

We claim:

1. A method of rendering an object from a text and numeric centric line of business application to a graphical user interface centric client application comprising:
a. requesting the object from a line of business application.;
b. the line of business application initiates host initiated display application program interface, and calling a workstation listener;
c. the content manager host sending the customer application request to a workstation listener;
d. the workstation listener launches the content manager graphical user interface client;
e. the content manager graphical user interface client builds the request for the object and sending it to the content manager application for host initiated display; and
f. content manager application responding to the content manager client and rendering the object to the user.

2. The method of claim 1 wherein the requested object is selected from the group consisting of displays, prints, and folder contents.

3. A computer system comprising a client application, a resource manager, a library server. and a line of business application, and a host initiated display application program interface between the line of business application and the client application.

4. The computer system of claim 3 adapted to render an object from a text and numeric centric line of business application to a graphical user interface centric client application by the steps of:
a. requesting the object from a line of business application;
b. the line of business application initiating a host initiated display application program interface, and calling a workstation listener;
c. the content manager host sending the customer application request to a workstation listener;
d. the workstation listener launches the content manager graphical user interface client;
e. the content manager graphical user interface client builds the request for the object and sending it to the content manager application for host initiated display; and
f. the content manager application responding to the content manager client and rendering the object to the user.

5. The computer system of claim 4 wherein the requested object is selected from the group consisting of displays, prints, and folder contents.

6. A program product comprising computer readable code for configuring and control a computer to render an object from a text and numeric centric line of business application to a graphical user interface centric client application by the steps of:
a. requesting the object from a line of business application.;
b. the line of business application initiating a host initiated display application program interface, and calling a workstation listener;
c. the content manager host sending the customer application request to a workstation listener;
d. the workstation listener launches the content manager graphical user interface client;
e. the content manager graphical user interface client builds the request for the object and sending it to the content manager application for host initiated display; and
f. the content manager application responding to the content manager client and rendering the object to the user.

7. The program product of claim 6 wherein the requested object is selected from the group consisting of displays, prints, and folder contents.
